(19) United States
(12) Patent Application Publication
(10) Pub. No.: US 2004/0161574 A1
(43) Pub. Date: Aug. 19, 2004

(54) Mobile wood joinery

(76) Inventor: Malcolm Gibson Hodgskiss, Hamilton (CA)

Correspondence Address: Malcolm Gibson Hodgskiss, 112 St Josephs Dr #307, Hamilton, ON, L8N 2E7, CA

(21) Appl. No.: 10/779,011

(22) Filed: Feb. 17, 2004

Related U.S. Application Data
(63) Continuation-in-part of application No. 09/846,228, filed on May 2, 2001.

(51) Int. Cl. B32B 3/10

(52) U.S. Cl. 428/44; 428/53

(57) ABSTRACT

The durable products of prior art woodworking have always been unyielding constructions of individual wooden elements held and forced rigidly in place by rigid means such as joinery, fasteners, adhesives, or supporting structures. In the present invention a new method of mobile wood joinery alone is used to draw the wooden elements into place while yet allowing them a range of motion. The joinery of the present invention is mobile, resilient, elastic, and dimensionally dynamic and so are the products made using the present invention. In the present invention a width of resilient elastic adhesive is bonded to the adjoining surfaces of the unmilled individual wooden elements of a wooden product. When the adhesive dries, a mobile, resilient, elastic, dimensionally dynamic joint has been formed. This joint can be bent, hinged, stretched, or compressed in many different directions. The individual wooden elements joined using the present invention can move independently of each other. The joint formed by the present invention is inexpensive and easy to form, yet will not be destroyed or loosened by impact during use or by dimensional swelling and contracting of the individual wooden elements it draws together. The individual wooden elements will not be permanently displaced or damaged by impact or by swelling and contracting of the wood, but will always be drawn back to their original correct positions by the mobile joinery of the present invention. A continuously smooth entirely wooden surface may be formed using the present invention. Alternatively a wooden surface that is substantially continuous may be formed having resilient, elastic, dimensionally dynamic joints visible at its surface that are less than 1/16″ wide.

### A CONTINUATION IN PART

This application repeats a substantial portion of application Ser. No. 09/846,228 filed May 2, 2001 and adds and claims additional disclosure not presented in the prior application. Since this application names the sole inventor named in the prior application it may constitute a continuation in part of the prior application. The applicant desires to obtain the benefit of the filing date of the prior application.

### BACKGROUND OF THE INVENTION

The durable products made of wood have all been assemblies of wooden pieces held rigidly in place by various means. However, this rigidity of construction has pitted joinery, fasteners, adhesives and supporting structures against powerful expansion forces inherent in wood. Many problems result from this basic conflict between prior art joinery techniques and the dimensionally dynamic character inherent in wood. Wooden products are torn, crushed, split, cracked, weakened and destroyed. Further, a great deal of wood use and expense occurs in the use of prior art joinery. The present invention eliminates these shortcomings of prior art joinery by using a new joinery technique that is more dimensionally dynamic than the wood it joins.

This invention relates to the methods by which the individual wooden elements of various wooden products are held together to form these products. Durable wooden products have been made using two or more of the following four methods.

The first method of prior art is wood joinery such as: mortise and tenon or tongue and groove and the like. Here, appendages are generally precisely milled into the surfaces of wooden pieces that are to be held together. Milling the joinery produces a great loss of useable wood. In the case of flooring, a plank of wood 50 mm (two inches) wide by 19 mm (0.75 inches) thick in its unmilled form will have a usable width of only 44 mm (1.75 inches) and a usable thickness of less than 6 mm (0.25 inches) after tongue and groove joinery have been added. This loss occurs when a 19 mm (0.75 inches) thick tongue and groove plank wears down 6 mm (0.25 inches). The groove splits off and the tongue is exposed. This renders the remaining 13 mm (half inch) thickness unserviceable. This means that about seventy five percent (75%) of the useable wood volume is lost because of tongue and groove joinery. However, the present invention does not require expensive milling or precise fitting. In the present invention the individual wooden elements need only to be cut or loosely shaped rather than precisely milled. As a result one hundred percent (100%) of the wood volume is used without any loss due to the millwork.

Another shortcoming of prior art joinery occurs in the case of prefinished wooden floors. The joinery of prefinished flooring is always milled to fit. However, when the wood is installed at a later time dimensional fluctuations (due to temperature and moisture variations) of the wood itself have slightly displaced the original joinery. As a result, prefinished wooden floors are made with a ‘V’ groove, a bevel, or a micro bevel to accommodate this joint displacement. This bevelled edge results in a floor that is not smooth and even and catches grit. However, the joinery of the present invention is resilient and elastic and moves with dimensional fluctuations of the wood without displacing the joints. As a result prefinished wooden floors that are smooth even and level and have no bevel can be made with the present invention.

Further, prior art wooden floors must be precisely milled finished and laid piece by piece. This leads to a great deal of expense. However, wooden flooring that is made in the present invention may be formed into a continuous flat unbroken pre-laid wooden surface which is rollable and can be finished, transported and installed more easily as a single piece or roll of material. In the present invention the individual wooden pieces need only be accurately cut rather than thoroughly and precisely milled.

A second method of prior art is the use of fasteners such as nails, screws, clamps, hinges, dowels, and others. These fasteners are an additional cost and take effort to use. They can cause damage to wood such as splitting even if pilot holes are drilled (another expense). When the wood moves against the fasteners it makes an unpleasant squeaking and the fasteners can rust, thus further damaging the wood. Fasteners often need to be counter sunk below the surface and concealed with wood filler or they detract from the appearance of the product.

The present invention avoids the cost and damage associated with the use of fasteners of any kind.

The third method used in prior art to hold together the individual wooden elements of wooden products is that of a supporting structure of wood, masonry, plastic, or other material. In the case of flooring the supporting structure may be a sub floor of plywood or of concrete. The flooring planks are then nailed or glued to the sub floor and held rigidly in place. The ribs of a boat may be a supporting structure that holds together the pieces of the hull.

Supporting structures have no immediate use in themselves but are a cost necessary to hold the useful wooden elements together in place just as nails or joinery are an expense.

An example of this is the wooden decking of some boats. The decking is held together by framing within the hull or by a surface of the hull to which the decking is attached. The present invention improves over prior art where supporting structure's hold the individual elements in place because the present invention requires no supporting structure.

The forth method used in prior art to hold the individual elements of wooden products together is adhesives. Adhesive application may be used to supplement joinery or fastenings that would otherwise be loose and weak or it may be used to hold pieces of wood to a supporting structure.

Adhesives may be applied to pieces of wood, which are then clamped tightly together to produce laminated wood products. However, prior art adhesive applications and prior art methods generally, hold the individual wooden elements of wooden products rigidly in place to produce products of an unyielding construction character. This rigidity of construction pits the strength of joinery, fasteners, supporting structures, and adhesives against the natural expansion forces of the wood. The wood expands and contracts due to humidity, temperature, species of wood and even character of wood such as heartwood, sapwood or knots. Over time this dimensional instability of wood will loosen and tear fasteners, joinery and adhesives free, destroying the wooden product or requiring costly repairs. In the case of wooden floors dimensional instability of wood can lead to squeaking, buckling, or compression set crack between boards as the wood fibre itself is crushed permanently by expansion, and then opens up as the board contracts.

The present invention avoids the expense and shortcoming of prior art discussed above by moving, compressing or stretching to accommodate dimensional fluctuations of the wood itself or impact from use.

### BRIEF SUMMARY OF THE INVENTION

The present invention of Mobile Wood Joinery joins individual pieces of a wooden product together while still allowing them a range of motion. Mobile wood joinery accommodates the natural expansion and contraction of wood and thus prevents damage to the wooden structure. Flexible joinery of the present invention provides further unique advantages. A ‘wooden rug’ may be made that is flexible and so adapts to contours in underlying substrates. If the ‘wooden rug’ is made to fill an entire room it constitutes a prefinished, pre-laid, hardwood floor that has no ‘V’ groove or bevel, has no cracks or fasteners and thus does not squeak under foot. This remedies several long-standing problems inherent in prior art wood flooring products while reducing lumber use by 70%. A prefinished pre-laid floor may be made using the joinery of the present invention that is only ⅛ of an inch thick. Prior art tongue and groove flooring cannot be made this thin because the tongue and grooves would only be 1/24 inch thick. This is too thin for milling and for use.

### BRIEF DESCRIPTION OF THE DRAWING

In the drawing which illustrate embodiments of the invention, FIG. 1 is a top view of one embodiment of the invention. FIG. 2 is a frontal view of FIG. 1. FIG. 3 is an enlargement of area A of FIG. 2. FIG. 4 is a top view of a second embodiment of the invention. FIG. 5 is a frontal view of FIG. 4. FIG. 6 is a frontal view of a third embodiment of the invention. FIG. 7 illustrates a frontal view of a variation of the third embodiment of the invention.

FIGS. 1, 2, and 3 illustrate an embodiment of the present invention consisting of a patterned ‘wooded rug’. This ‘wooden rug’ is made of a number of unmilled wooden pieces indicated by No. 1, placed in a pattern. A resilient elastic dimensionally dynamic joinery material indicated by No. 2 is then applied to fill the spaces between the unmilled pieces of wood. When the material dries, the traffic surface is sanded and finished with varnish or the like. A smooth even level portable wooden floor surface is produced. In this embodiment the joint spaces between the individual wooden elements may be less than 1/16 of an inch.

FIGS. 4 and 5 illustrate a second embodiment of the present invention consisting of unmilled strips of wood 1 of equal width and thickness but of random lengths laid side by side. The space between the strips is then filled with resilient elastic dimensionally dynamic joinery adhesive 2. The resulting panels are sanded and finished with varnish or the like. A prefinished wooden floor panel is produced that is smooth, even and level and has no over-wood catch, no ‘V’ groove, no bevel or micro bevel. The panel is resilient and flexible not rigid, so it can accommodate contours and irregularities in substrates upon which it rests. This prefinished wooden floor panel may be fastened to one or more similar panels by means of a hook loop fastener or an adhesive tape 4 applied to the bottom of the seam. Then joinery material 2 may be applied to the seam and tooled smooth. In this way a prefinished floor can be installed in any size of room. Alternately a single large panel may be made that can be rolled up for transport. This eliminates the need to join panels.

FIG. 6 shows a third embodiment of the invention, wherein an alternate joint profile is shown. The wooden strips contact each other directly at the upper portion of their adjoining edges. The alternate joint profile shown ensures that the product of wood joinery has a continuous entirely wooden upper surface. In FIG. 6. the same reference numerals have been used to indicate structures which are common to the first, second, and third embodiments, with individual wooden elements (ie. either individual wooden pieces or strips of wood) being indicated by reference numeral 1 and with adjacent edges of the individual wooden elements 1 being indicated by reference numeral 3).

FIG. 7. depicts a variation of the third embodiment of the invention shown in FIG. 6. In FIG. 7 the chamfer or bevel of the joint profile extends the full thickness of the adjoining and contacting edges of the individual wooden elements such that the chamfered joint edge intersects with the continuous wooden surface provided by the present invention. In FIG. 7 individual wooden elements are indicated by the reference number I and their contacting adjacent adjoining edges indicated by the number 3. A continuous entirely wooden surface is illustrated in FIG. 7.

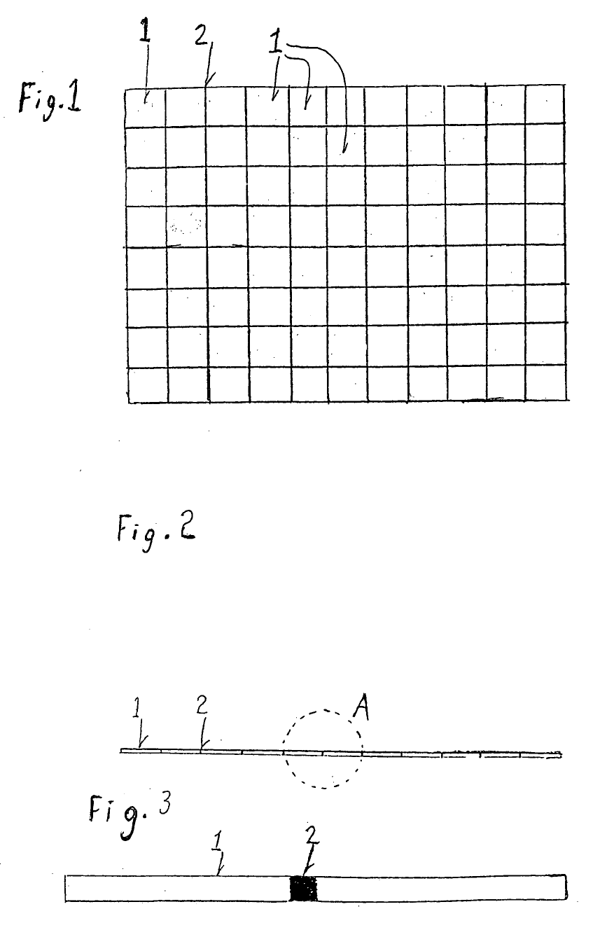

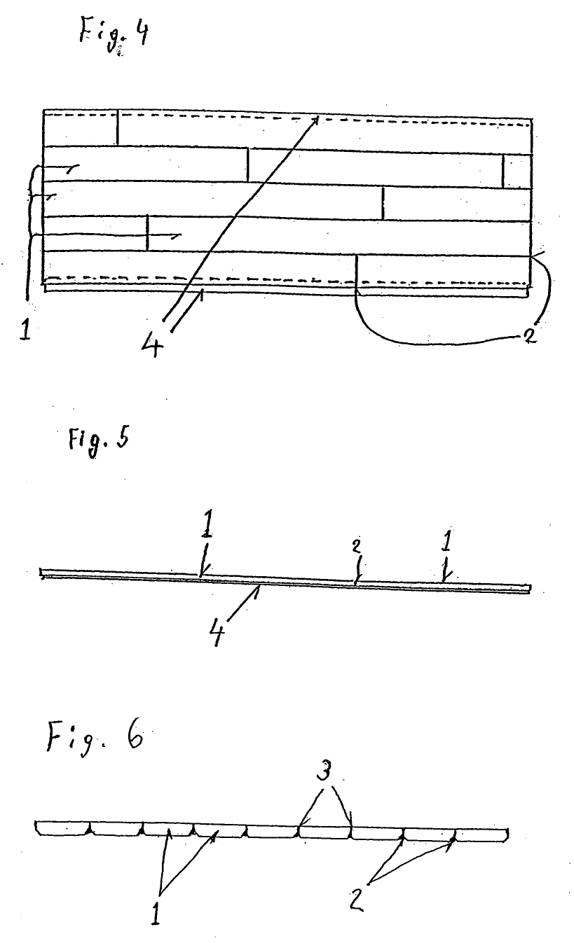

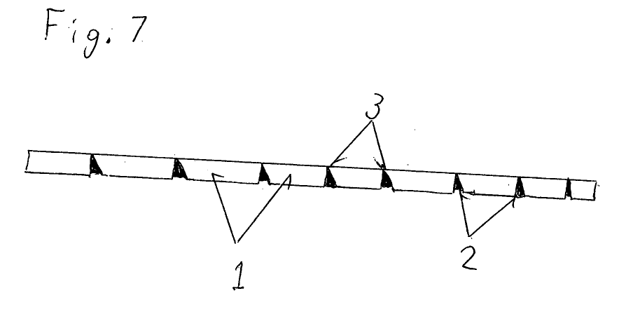

### DETAILED DESCRIPTION

The inventive utility of the present invention may be further illustrated by several specific comparisons with prior art.

The joinery of conventional woodworking is rigid and unyielding. Each joint must be strong enough to withstand the expansion forces of the wood and impact forces from use. Otherwise the joint will fail. Further because each joint in conventional woodworking does not yield or give to movement forces in the wood from expansion or form the impact of use. These forces multiply, build up and become magnified and concentrated, until they are released by a failure of the weakest point in the assembly. Thus the rigid joints of conventional woodworking must be very strong. The wood must be thicker, precisely milled and forcefully clamped in assembly without voids or the product will not withstand the forces of use and those inherent in the wood itself. Ultimately the product will fail anyway. Everyone has thrown out a split cutting board, or a chair or desk that has become rickety, loose and weak as a consequence of these forces. Everyone has walked across a hardwood floor that moves and squeaks like a symphony orchestra because the wood has worked loose of its joinery and fastenings. However, the joinery of the present invention is mobile, resilient and flexible it gives and yields to forces from expansion of the individual wooden elements and from the impact forces of use. Further the joinery of the present invention gives and yields to these forces at every joint. In the present invention these forces do not build up multiply and become focused and concentrated at the weakest point. They are dispersed. Consequently the joinery of the present invention does not need to be so strong, so thick, so precisely milled or so forcefully formed as that of conventional woodworking.

Prior art produces a rollable wooden surface in the form of a roll top desk. Rollability is provided by attaching the wood strips to a canvass carrier sheet or by the use of a hinge and track. The rollable or flexible surface is relatively complicated and costly of construction compared to the present invention and only allows for a broken or interrupted wooden surface while the present invention allows for a continuous, unbroken wooden surface.

Prior art produces a continuous smooth wooden surface in the form of a cutting board. Cutting boards must be thick because each joint must be stronger than the tremendous expansion forces of wood and the impact forces of use. Because the joints or laminations in it do not yield, the force applied to one joint can move, magnify, multiply and concentrate at any point in the construction. Ultimately such forces come to bear at the weakest joint on the board and causes it to split. Or they may warp and cup the entire board. This also limits the size which a good cutting board can be made by prior art methods. Additionally the laminated joints of a cutting board made by prior art methods must be precisely milled and assembled tightly with heavy clamps, otherwise the board will be weak and prone to fail. In a cutting board formed with the joinery of the present invention however the joint is resilient and flexible and can accommodate and yield to the forces applied to it at each individual joint in the board. Consequently the joint does not need to be as strong, as precisely milled carefully formed or as thick as in a conventional cutting board. A cutting board made with the joinery of the present invention can be made easier, thinner, larger in area, and will be less prone to split and warp than a cutting board made by prior art methods.

Another product made by prior art methods is prefinished wooden flooring. A prefinished wooden floor is presently made in the following way with prior art techniques.

(1) Lumber is dressed and cut to size;

(2) The dressed lumber is milled on (a) the top; (b) the bottom, (c) the sides, (d) the ends to provide its tongue and groove joinery.

(3) A bevel must be installed on the sides and ends of each plank or the installed floor will have sharp edges on every plank.

(4) Each plank must be individually (a) sanded, (b) stained, and (c) finished. The wooden planks are then

(5) Counted

(6) Packaged

(7) Transported for installation.

(8) Prior to installation existing doors and trim need to be raised to allow for the substantial thickness of the plank.

(9) Then each plank must be laid individually by costly, skilled labour on site.

Each plank of the floor so installed is held in position and its edges held down by the tongue and groove joinery of each plank and by nails or adhesive. The installed floor is not smooth or level because there is a surface bevel at the edges of each piece, it is costly because of the extensive millwork, substantial wood use, consequent transportation costs, individual finishing, and installation of each piece and the labour of cutting back existing doors and trim. This floor will squeak in time as it will loosen on its fastenings. Further it is highly susceptible to water damage as there are cracks between each piece that will widen in time and allow water to flow into the wooden floor. The planks of such a floor must be fairly wide or the millwork and installation costs will be even higher as the number of pieces in the floor increases.

However, using the mobile wood joinery of the present invention a prefinished wooden floor that is a perfectly flat continuous wooden surface may be made that is different, better and less costly. The process of making a flat continuous wooden floor surface in the present invention might be that

(1) Lumber is dressed and cut with veneer cutting techniques.

(2) The veneer already smooth and consistent in thickness is cut into strips. In cutting one side of each strip the cut is angled so that the strip has a bevelled edge suitable for the joinery of the present invention.

(3) The strips are fed into an automated machine that joins them according to the present invention into a smooth, continuous pre-laid, rollable wooden surface of perhaps one eighth (⅛) of an inch thick

(4) The entire wooden surface produced by the automated machine is stained, finished, and rolled up.

(5) The prefinished, pre-laid, roll of continuous, smooth, wooden floor surface is then transported for installation.

(6) It is fitted to the room and installed. A smooth, flat, continuous entirely wooden floor surface has been created.

General major steps, several smaller steps, and a great deal of wood and expense have been saved compared with prior art methods. The pre-laid, pre-finished wooden floor made with the joinery of the present invention is different from the prior art floor above, in many respects and superior in some ways also. It is lighter in weight, it is smooth because it has no bevels and because the individual wooden strips contact each other and are held and drawn flush by the joinery material. It may be squeak free or waterproof. It may be made in strips much thinner than used in prior art wooden flooring and narrower for a distinct appearance.

Finally there is the prior art joinery technique disclosed by Brown U.S. Pat. No. 391,760. Brown disclose a flexible, resilient, fluid resistant, sound dampening joint that can be used in woodworking. However, this prior art specified a joint width of 1/16 to ¾ of an inch without contact at all of the individual wooden elements. Thus this prior art does not provide a smooth flat continuous wooden surface as the present invention does. Brown discloses a flexible flooring construction having a broken traffic surface. The Brown construction is much like a corduroy road surface and does not allow for smooth rolling or sliding of furniture across it. Heavy objects rolled across the Brown construction would clank from one tile to the next thereby generating noise and resistance for the wheeled object. In contract the present invention is more akin to a paved road surface. The present invention provides a continuous, smooth, level, surface of wood.

This significant improvement in the present invention allows for wheeled furniture to roll smoothly over the traffic surface without resistance rather than sinking into the interrupted construction disclosed by Brown. The mobile wood joinery of the present invention has a number of additional unexpected advantages over the modular tiles disclosed by Brown. Aesthetically, the mobile wood joinery of the present invention will be seen to provide an entirely continuous wooden surface with negligible spaces or no spaces visible at the surface and it has much the same appearance as a conventional wooden floor surface or other product of woodworking. Functionally the mobile wood joinery of the present invention provides a surface of consistent hardness that does not have dangerous soft spots that might catch or snag a high heeled shoe. The present invention also avoids movement of the rubber joint at this traffic surface. Otherwise such joint movement at the surface might cause any finish applied to it to break, chip or peel.

As well as designs that provide for interstitial spaces between the tiles or wooden elements, compression of the rubber between such elements will naturally cause the joint to rise above the surface, thereby forming a catch or snag that could impede cleaning. Similarly stretching the joint would create a hollow that would hold dirt, dust, debris and even fluid. The present invention avoids both of these problems by providing a design wherein individual wooden elements together define a substantially or entirely unbroken and continuous wooden upper surface on the product of joinery of the present invention. Further an unbroken wooden surface avoids chemical reactions and compatibility problems between various joinery materials and various wood finishes.

Additionally the cross sectional geometry or shape of the present invention provides for a smaller joint volume and conserve joinery rubber, while also minimizing exposure of the joint to UV, cleaners, solvents, etc. There is significantly reduced wear on the joint and no ‘crazing’ or deterioration of the joint material is visible over time. The structure of the present invention may be used with joint thickness of 0″ or between 0″ and 1/16″ at the surface and even with any wood more than 1/50″ thick, more than 1/8″ wide and more than 1/2″ long.

Further the fact that the surface edges of individual wooden pieces in the present invention contact, allows for contact to serve as a guide and control, making assembly of woodwork of the present invention faster and easier. In Brown's invention, setting each wooden piece consistently and accurately a certain distance from the next piece all long its edges will be a very difficult and time consuming task especially if the wooden pieces are a little warped. Finally the broken or interrupted wooden surface disclosed by Brown has substantial rubber filled spaces or gaps between the unfinished wooden pieces at the upper surface or top of the joint while the present invention provides for a continuous, smooth, unbroken wooden surface or in some alternative embodiment a surface that is substantially so with spaces less than 1/16. This means that Brown's joinery cannot ‘draw’, ‘hold’, and ‘join’ the edges, surface and joint of his prior art together. Neither can Brown's joinery maintain surface cohesion and integrity or bolster and support the wooden joint edge as the present invention does. This is because Brown's invention discloses a substantial gap at each joint of between 1/16″ and 3/4″ while the present invention provides for a smooth unbroken wooden surface with no gaps at each joint of its construction or alternatively with a gap that is not substantial being less than 1/16″ at most. Because Brown's invention has substantial spaces between the individual wooden pieces it allows the wooden pieces substantial movement. This means that if the individual wooden pieces of Brown's invention expand, contract, warp and cup, or curl they can draw substantially apart from the other wooden pieces. This is so even if Brown's elastomeric joinery material remains attached to the wooden pieces when they move. When one wooden piece moves substantially in this way surface integrity and cohesion may suffer. The individual wooden piece may become isolated from the structure formed by Brown's invention. Consequently, it will be more prone to split or break when an impact force from traffic or other use strikes it. The ability of the present invention to bolster and support its joint edges and maintain surface integrity and cohesion is further discussed immediately following.

The elastic, resilient, dimensionally dynamic, mobile joinery material applied in the joinery of the present invention structurally stabilizes, bolsters, and strengthens the joints, wooden joint edges and wooden surfaces formed with the joinery of the present invention. This allows for wooden surfaces and structures to be formed by the present invention that are thinner, more structurally stable, and have better surface cohesion and integrity than prior art allows.

Again the case of a wooden floor provides a good illustration and comparison of prior art techniques relative to the present invention. In forming a wooden floor by prior art techniques each plank is joined to the tongue and groove joinery of the adjacent planks. Prior art joinery ‘holds’ and ‘forces’ the planks down in position forming a cohesive wooden surface. During installation coarse after coarse, row after row of planks are forced and driven tightly together by driving several large nails or cleats diagonally through the tongue on the side of each plank into the sub floor with a heavy blow from a large mallet. This forces and holds each plank tightly together into the joinery of the adjacent planks and forms a cohesive wooden surface. However, the upper tongue of the tongue and groove joinery of prior art flooring is not itself held in place or attached to the joint or the plank adjacent to it. In time tremendous forces of expansion and contracting will work the floorboards somewhat loose of their joinery and the cleats or nails holding them. The individual boards may warp, cup or even curl at the edges. When this happens cohesion and integrity and smoothness of the wooden surface has been lost. The upper groove of the tongue and groove joint can curl upward. Then it is not supported there is a space beneath it as it has curled upward. If impact occurs at this point the groove may split off damaging the wooden surface, perhaps destroying it. Further when the joint opens and curls like this, grit and grime will get into the floor joint itself leading to further displacement of the joint.

While prior art methods ‘force’ and ‘hold’ the wooden pieces together. The joinery of the present invention may in contrast be said to ‘join’, ‘hold’, and ‘draw’ the wooden pieces together and further to ‘join’, ‘hold’, and ‘draw’ the wooden surface formed by the wooden pieces together. Thus bolstering the joint and surface structure providing better surface cohesion and integrity than prior art. In the present invention individual wooden pieces and the surface they form are—“hold’, ‘drawn’, and joined’ in place and level relative to one another by joinery material that may be applied to the entire thickness of the edge of each wooden piece. This means that if expansion forces attempt to warp, cup or curl the individual wooden pieces in the present invention, they will be stabilized at the surface and along the entire thickness of their edges by their attachment at the surface and down the thickness of their edges to the adjacent piece of wood. If the expansion force of the wood is great enough, the edge of the strip may move or curl somewhat (though not as much as in prior art) but the edge of the adjacent strip and the joinery material of the present invention will move with it. Surface integrity and cohesion will thus be maintained. If an individual wooden piece has curled somewhat and an impact force strikes its edge, it will be structurally supported and bolstered by its attachment at the surface and down the full thickness of the adjoining edge to the adjacent wooden piece. Also the resilience and elasticity of the underlying joinery material itself will bolster and support the wooden surface and joint edges in the present invention. If a piece of an individual wooden element splits off near its joint edge due to impact it may still be held in place by the resilient elastic joinery material and surface integrity and cohesion may thus be maintained.

This difference also relates to Brown's prior art as Brown's invention allows for substantial spaces between the individual wooden pieces substantial movement or curling can occur in each individual piece. Surface cohesion and integrity will not be well maintained, individual wooden pieces will be isolated from the overall structure and thus more prone to break when an impact force strikes them in use.

A more detailed description of forming a joint in the present invention follows. The joinery of the present invention may be made with any grade, species, thickness, width, length or cut of wood used in conventional woodworking. Plywood, oriented strand board and so on might also be used.

The chosen wood stock may be dressed on a thickness plane then band sawed or table sawed to the desired thickness. Alternatively a veneer cutting machine may be used to cut according to the procedures of that art. Strips of wood may be produced or some other shape depending on what is being made and what its characteristics are to be.

A chamfer or bevel or some other profile shape may then be cut into the edges of these pieces of wood. A router, a table saw, a wood plane, a sander or other means may be employed to do this. The chamfer or bevel or other shape may be cut into both edges of a strip or only one edge. Only one edge is necessary to provide for joint formation in the present invention. In pieces that are shapes other than strips the number of sides that need to be cut for joint formation may also vary. In the use of a wooden strip the chamfer or . bevel may be cut through part of the thickness of the strip so that the chamfer or bevel allows for a partly square edge or shoulder on the edge of the strip. Alternately the chamfer or bevel may be cut through the full thickness of the strip at its edge so that the chamfer or bevel edge or other joint profile intersects with the top surface of the wooden strip. Certainly a great variety of joint configurations, profiles or shapes are possible while realizing the advantages of the mobile wood joinery of the present invention. It is noteworthy that the bevel, chamfer, or other joint configurations need not be cut with the same degree of precision (or cost) as in conventional woodworking for excellent results to be attained with the present invention. In the present invention the individual wooden elements need not interlock tightly but need only provide a space of some sort for the joinery material to be applied. Now that the wooden stock is prepared, the joinery material applied to form the joint of the present invention needs to be considered. This material may be any material of sufficient strength, elasticity, resilience, and adhesion to serve the particular application in mind when utilizing the joinery of the present invention. It may be a polyurethane, an epoxy, a polysulfide, a silicone, a hot melt, a moisture cured product, or polyethylene and so on. The joinery material is usually in a liquid state when applied.

Now that wood preparation, joint configuration, and joinery material in the present invention have been discussed joint formation itself needs to be addressed. Many methods can be used in bringing the prepared wooded pieces and joinery material together to form the joinery of the present invention. Depending on the species, grade, size and joint configuration, of the wooden pieces and depending on the article being made and the characteristics desired in it the following joint formation techniques may be used in the joinery of the present invention. Many other techniques are possible. To simply this description it will be assumed that strips of wood with a chamfer or bevel on one edge and a square edge on the other edge are being used. In one method the pieces may be laid side by side so that the chamfered side of one piece abuts the square edged side of the other. A groove is thus formed and may be filled with joinery material to form the joint of the present invention. In another method a bead of joinery material is applied to the chamfered bevelled edge of one piece and the square edge of another piece is then brought into contact with the bevelled edge of the first piece.

Another method is to press pieces together rather than place them together as above then apply the joinery material to the groove that is formed between the strips so pressed together.

Another method is to apply the joinery material to the chamfered edge of one piece then press the square edge of a second piece into the joinery material until it abuts the chamfered or bevelled edge of the first piece. With thicker wood, or wood of lower grade it may be necessary to clamp the pieces as in conventional woodworking in order to form the joinery of the present invention.

Another method that may be used to form the joinery of the present invention is to place the pieces on a tacky surface so that they abut one another as above then apply the joinery material to the groove formed.

Another method that may be used when working with thicker wood that has warped is to clamp them into position so that they abut edge to edge as above than apply the joinery material to the groove formed. Or the joinery material may be applied to the edge of one piece before they are clamped together.

In the present invention as the individual wooden elements can be formed into a continuous level, unbroken, pre-laid wooden surface at the point of manufacture and at the moment the strips are cut from larger pieces of wood they do not have the opportunity to warp and cup as the conventional flooring or other wooden manufacturers do before they are assembled into a complete wooden assembly such as a floor surface. Consequently the mobile wood joiner of the present invention may be formed without the powerful, forceful, clamping, and laminating techniques of conventional woodworking. Indeed the individual wooden elements joined in the present invention may be merely pressed or even laid together without force at all rather than tightly and forcefully clamped and unclamped.

Further because the mobile wood joinery of the present invention allows for stable pre-laid serviceable durable continuous wooden surfaces to be formed with thinner and narrower pieces of wood than conventional woodworking allows, powerful forceful clamping and unclamping of heavy thick wooden pieces is not necessary in the present invention. Instead the individual wooden elements joined in the present invention need only be lightly pressed together or even laid together without force.

The properties and qualities of the wooden article made with the joinery of the present invention may be that of a smooth, level, continuous, waterproof, pre-laid, squeak free, light weight, flexible, rollable entirely wooden surface depending on how the joint is formed, the joinery material used and the joint configuration.

Specifically if the joinery material is applied all the way from the top edge to the bottom edge of the strip the mobile wood joint will tend to have different properties than if it contacts only part of the edge of the strips. In the former case where the joinery material contacts the entire edge of the strips joined it is likely to be squeak free and waterproof. It will be squeak free because the joinery material so applied will not allow the contacting edges of the wooden strips to move against each other in use and so they will not squeak. Secondly it will dampen the vibration if they do somehow move against each other. A joint so formed may be waterproof as it does not afford any space between the strips for liquids spilled onto the surface to flow into. Alternatively a joint formed with joinery material contacting only part of the thickness of the edge would tend to be more flexible as would a joint configuration where the chamfer or bevel was the full thickness of the strip and intersecting with the continuous, unbroken, flat wooden surface provided by the present invention. The present invention also provides for a gap or joint seam of joinery material of less than 1/16″ at the upper surface as well as for an entirely wooden surface without gaps, or spaces at each of its joints.

The applications for the joinery of the present invention might include flooring and wall covering, continuous pre-laid rollable wooden flooring material, a wooden drape, a blind, a screen, a chair mat for office chairs, an office partition, a cutting board, a paddle or oar, a wooden shower lining, or boat, or aircraft, and vehicle interiors, portable floors, and walls for homes dances or commercial trade show booths.

It is clear that the present invention can provide for a continuous smooth wooden surface or alternatively a substantially continuous surface with joint seams less than 1/16″. By arranging and joining in succession of strips as above such a surface would be formed. This surface might or might not require sanding and finishing. Dedicated machines might be built for this purpose as well.

In the development of the present invention a number of different resilient elastic adhesives were tested. The thickness of the adhesive joints ranged from 1.5 mm (0.06 inches) to 19 mm (0.75 inches) and the depth also ranged from 1.5 mm (0.06 inches) to 19 mm (0.75 inches). The thickness of wood joined similarly ranged from 1.5 mm (0.06 inches) to 19 mm (0.75 inches). A variety of different woods were tested including red oak, ash, maple, walnut, spruce, and pine. The criteria were strength of bond to the wooden element, tensile strength of the adhesive joint itself, and resiliency, elasticity and mobility of the adhesive joint itself. The results ranged from good to excellent depending on the kind of resilient elastic dimensionally dynamic material used rather than depending on the species of wood or the width and depth of the adhesive joint. Elastic joinery that is thinner or thicker than the range described above is certainly possible.

In other experiments the individual wooden elements were placed in contact along their adjoining edges at the upper surface thus providing for a smooth flat, continuous entirely wooden surface to be made with the present invention. This embodiment provides for many inventive advantages in the present invention over prior art methods.

Secondly many of the advantages provided by the embodiment of the invention where the adjoining adjacent surface, and near surface edges of the individual wooden pieces contact to form a continuous, smooth wooden surface may be retained when the surface edges of the individual wooden elements do not contact each other but instead nearly contact each other. In this case the joint width between the individual wooden elements at their adjoining edges and specifically at the top surface of those edges may be between 0″ to 1/16″. This provides for a substantially unbroken, substantially continuous wooden surface aesthetically and in many functional ways also. For example when individual wooden pieces expand, contract, warp, cup or curl substantially contacting joints between the individual wooden elements of less than 1/16″ will limit the curling or cupping and thus stabilize the surface structurally and maintain surface cohesion and integrity to a greater extent than when the resilient joint has a width of 1/16″ to ¾″ at the surface. In the present invention the individual wooden elements may contact one another at the top of their adjoining adjacent edges to form a continuous smooth entirely wooden upper surface. Alternatively contact of the individual wooden elements may be at the bottom of their joint edges.

A third possibility is that the individual wooden elements might contact somewhere between their top and bottom edges.

Resilient elastic adhesive that performed well in the above trails included a moisture cured urethane rubber with an elongation at break of more than 250%, a tensile strength of 190 psi, excellent adhesion, shore ‘A’ hardness (DIN 535050) of 35-40, and a tear propagation strength of 1450 psi. Another successful material was a poly ether adhesive which had similar properties to the moisture cured urethane described above except that it had a 500% elongation at break. Certainly many different adhesives would have adequate resilience, elasticity, adhesion, and strength to serve in the present invention.

What is claimed is:

1. A resilient, elastic, dimensionally dynamic, mobile, product of adhesive wood joinery complete in itself without fasteners, joinery millwork, or supporting structures, wherein said product of adhesive wood joinery comprises at least two individual wooden elements and a resilient, elastic dimensionally dynamic and mobile adhesive joint between the individual wooden elements wherein adjacent edges of the individual wooden elements contact each other such that the individual wooden elements together define a smooth and continuous wooden upper surface of said product of adhesive wood joinery.

2. The product of adhesive wood joinery of claim 1 wherein the joints exhibit hinge like flexibility in at least one direction.

3. The product of adhesive wood joinery of claim 1 wherein the individual wooden elements move freely and independently of each other.

4. The product of adhesive wood joinery of claim 1 wherein the wooden elements joined are not displaced permanently by impact or expansion but are drawn back to their original position.

5. The product of adhesive wood joinery of claim 1 wherein the wooden elements joined need not be precisely milled for a perfectly tight joint to be formed.

6. The product of adhesive wood joinery of claim 1 wherein an individual wooden element is a single piece of wood more than 1/50 of an inch thick.

7. The product of adhesive wood joinery of claim 1 wherein an individual wooden element is a single piece of wood more than ½ of an inch long.

8. The product of adhesive wood joinery of claim 1 wherein an individual wooden element is a single piece of wood more than ⅛ of an inch wide..

9. The product of adhesive wood joinery of claim 2 wherein the wooden elements move freely and independently of each other.

10. The product of adhesive wood joinery of claim 2 wherein the wooden elements joined are not displaced permanently by impact but are drawn back to their original position.

11. The product of adhesive wood joinery of claim 2 wherein the individual wooden elements need not be precisely milled or fitted for a perfectly tight joint to be formed.

12. The product of adhesive wood joinery of claim 1 wherein the adjoining edges of the individual wooden elements contact each other at their adjacent bottom surface.

13. The product of adhesive wood joinery of claim 1 wherein the adjoining edges of the individual wooden elements abut and contact each other at a point between their bottom and top surface.

14. The product of adhesive wood joinery of claim 1 wherein the individual wooden elements are joined held and drawn together across the entire depth of their adjoining edges by the resilient, elastic, dimensionally dynamic, mobile joinery material of the present invention.

15. The product of adhesive wood joinery of claim 1 wherein the continuous entirely wooden surface is joined held and drawn into place by the mobile, elastic, resilient dimensionally dynamic joinery material of the present invention.

16. The product of adhesive wood joinery of claim 1 wherein the wooden joint edge of the individual wooden element is structurally stabilized by its upper surface contact, and complete attachment down its entire depth, to the wooden joint edge surface of the adjacent wooden element.

17. The product of adhesive wood joinery of claim 1 wherein surface cohesion and integrity of the continuous entirely wooden surface is maintained by the individual wooden elements adjoining each other across the entire depth of their edges right to the continuous entirely wooden upper surface they form.

18. The product of adhesive wood joinery of claim 1 wherein adjacent adjoining edges of the individual wooden elements may be any distance less than 1/16 of an inch apart at their upper surface.

19. The product of adhesive wood joinery of claim 2 wherein the adjoining edges of the individual wooden elements contact each other at their adjacent bottom surface.

20. The product of adhesive wood joinery of claim 2 wherein the adjoining edges of the individual wooden elements abut and contact each other at a point between their bottom and top surface.

21. The product of adhesive wood joinery of claim 2 wherein the individual wooden elements are joined held and drawn together across the entire depth of their adjoining edges by the resilient, elastic, dimensionally dynamic, mobile joinery material of the present invention.

22. The product of adhesive wood joinery of claim 2 wherein the continuous entirely wooden surface is joined held and drawn into place by the mobile, elastic, resilient, dimensionally dynamic joinery material of the present invention.

23. The product of adhesive wood joinery of claim 2 wherein the wooden joint edge of the individual wooden element is structurally stabilized by its upper surface contact, and complete attachment down its entire depth, to the wooden joint edge surface of the adjacent wooden element.

24. The product of adhesive wood joinery of claim 2 wherein surface cohesion and integrity of the continuous entirely wooden surface is maintained by the individual wooden elements adjoining each other across the entire depth of their edges right to the continuous entirely wooden upper surface they form.

25. The product of adhesive wood joinery of claim 2 wherein adjacent adjoining edges of the individual wooden elements may be any distance less than 1/16 of an inch apart at their upper surface.

26. The product of adhesive wood joinery of claim 2 wherein the individual wooden elements are any pieces of wood that are greater than 1/50 of an inch thick, greater than ⅛ of an inch wide and greater than ½ an inch long.

27. The adhesive wood joinery of claim 2 wherein the individual wooden element contact each other at the upper portion of their adjoining edge surface forming a smooth continuous entirely wooden top surface thereby.

28. The joinery of claim 1 wherein expansion forces of the wooden elements and impact forces from use are dispersed at the joint itself.

29. The joinery of claim 2 wherein expansion forces of the wooden elements and impact forces from use are dispersed at the joint itself.
